(19) United States
(12) Patent Application Publication
(10) Pub. No.: US 2019/0199132 A1
(43) Pub. Date: Jun. 27, 2019

(54) CONTACTLESS POWER TRANSMISSION APPARATUS AND CONTACTLESS POWER TRANSMISSION METHOD

(71) Applicants: Yuki OTA, Miyagi (JP); Tetsuya TAKURA, Miyagi (JP); Fumihiro SATO, Miyagi (JP); Hidetoshi MATSUKI, Miyagi (JP); Tadayuki SATO, Miyagi (JP); Akifusa YUYAMA, Miyagi (JP); Shu SASAKI, Miyagi (JP); Toshiaki KATO, Miyagi (JP)

(72) Inventors: Yuki OTA, Miyagi (JP); Tetsuya TAKURA, Miyagi (JP); Fumihiro SATO, Miyagi (JP); Hidetoshi MATSUKI, Miyagi (JP); Tadayuki SATO, Miyagi (JP); Akifusa YUYAMA, Miyagi (JP); Shu SASAKI, Miyagi (JP); Toshiaki KATO, Miyagi (JP)

(21) Appl. No.: 14/425,200

(22) PCT Filed: Feb. 24, 2014
(86) PCT No.: PCT/JP2014/054309

§ 371 Date: Mar. 2, 2015

(30) Foreign Application Priority Data
Sep. 3, 2012 (KR) 10-2012-0097193

(51) Int. Cl. H02J 50/10; H02J 50/40; H02J 7/02; H01F 38/14; H01F 27/28

(52) U.S. Cl. CPC H02J 50/10; H02J 50/40; H01F 27/28; H01F 38/14; H02J 7/025

(57) ABSTRACT

In a power transmission system for transmitting electric power from the primary side power feeding coil to the secondary side power receiving coil without their mutual contact and using electromagnetic induction, the power coils on each of the primary and secondary sides include a pair of planar spiral coils which are shaped in the form of a figure 8 and connected differentially to power supply, and each of the spiral coils is D-shaped having a semicircular portion and a linear portion combined together, the two spiral coils having their linear portions laid one on the other to form a planar figure-8 coil. Plates of soft magnetic material 4 and 41 are disposed each on a side of the power coil on one of the primary and secondary sides which is opposite to the side that faces the power coil on the other of the primary and secondary sides.

### TECHNICAL FIELD

The present invention relates to a contactless power transmission system and a contactless power transmission method using figure-8 coils for feeding and receiving electric power without the intervention of an electric contact or connector.

### BACKGROUND ART

In conventional contactless power transmission systems, two spiral coils are opposed to each other across a gap spacing and one of the spiral coils is fed with an input electric power for effecting power transmission.

Patent Document 1 describes a contactless power transmission device which comprises a power feeding coil and a power receiving coil for electric power transmission, each of the coils being a spiral coil. Inside of the power receiving and feeding coils for power transmission there are embedded a signal sending coil and a signal receiving coil, respectively, for signal transmission.

### PRIOR ART REFERENCE

### Patent Reference

Patent Document 1: JP 2008-288889 A

### SUMMARY OF THE INVENTION

### Problems to be Solved by the Invention

In the conventional contactless power transmission systems, no measure has been taken for a power feeding coil and a power receiving coil against noises, especially to reduce noises which the power feeding coil itself and the power receiving coil itself are generating.

While in Patent Document 1 a signal sending and a signal receiving coil, each of a figure-8 shape, embedded in a power feeding and a power receiving coil are described to counter noises, there is no mention or suggestion of a countermeasure to reduce the noises which the power feeding and receiving coils themselves are generating.

It is an object of the present invention to provide a contactless power transmission system and method which can cancel out noises that are being emitted outwards of a primary side and a secondary side power coil themselves in electric power transmission, can reduce leakage magnetic fluxes from the primary and secondary power coils, can respond to a deviation in position of the primary side coil and can maximize the efficiency of power transmission.

### Means for Solving the Problems

In accordance with the present invention there is provided, as set forth in claim 1, a contactless power transmission system, characterized in that it comprises:

a power feeding coil made up of a plurality of power coils disposed adjoining one another on a primary side and

a power receiving coil made up of a plurality of power coils disposed adjoining one another on a secondary side, wherein

a said plurality of adjoining power coils on each of the primary and secondary sides are positioned and laid one on another to coincide in part so that a noise from a leakage electromagnetic field being generated during power transmission, an external noise and a noise that the power feeding and receiving coils themselves are emitting outwards are thereby canceled out.

The term “a plurality of adjoining power coils” here is used to mean power coils which lie on a common plane and which in part coincide, contact or overlap with each other.

In accordance with the present invention there is also provided, as set forth in claim 2, a contactless power transmission system for transmitting electric power from a power feeding coil to a power receiving coil without their mutual contact and using electromagnetic induction, characterized in that:

the said power feeding coil is made up of a plurality of power coils disposed adjoining one another on a primary side, a said plurality of adjoining power coils on the primary side generating magnetic fluxes varied in orientation from one another,

the said power receiving coil is made up of a plurality of power coils disposed adjoining one another on a secondary side, a said plurality of adjoining power coils on the secondary side generating magnetic fluxes varied in orientation from one another, and

the said adjoining power coils on each of the said primary and secondary sides are positioned and laid one on another to coincide in part so that a noise from a leakage electromagnetic field being generated during power transmission, an external noise and a noise that the said power feeding and receiving coils themselves are emitting outwards are thereby canceled out.

The present invention further provides, as set forth in claim 3, a contactless power transmission system as set forth in claim 1 or claim 2, characterized in that the said adjoining power coils on each of the said primary and secondary sides comprise a pair of planar spiral coils which are shaped in the form of a figure 8 and connected differentially to power supply, and each of the said spiral coils is D-shaped having a semicircular portion and a linear portion combined together, the two spiral coils having their linear portions laid one on the other to form a planar figure-8 coil. The term “semicircular” here is used to refer to “of half a circle” but is not limited to the particular shape.

The present invention specifically further provides, as set forth in claim 4, a contactless power transmission system as set forth in any one of claims 1 to 3, characterized in that a said plurality of the adjoining power coils on the said primary side have a single power supply for connection thereto.

The present invention specifically also provides, as set forth in claim 5, a contactless power transmission system as set forth in any one of claims 1 to 3, characterized in that a said plurality of the adjoining power coils on the said primary side have a plurality of power supplies for connection thereto. Providing a plurality of power supplies for connection to power coils on the primary side allows electric currents for passage through the adjoining power coils to be individually adjusted, proving a contactless power transmission system of an improved efficiency of power transmission.

The present invention specifically provides, as set forth in claim 6, a contactless power transmission system as set forth in claim 3, characterized in that on the primary side a plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a said figure-8 coil on the secondary side, leading to a lowering of power transmission efficiency, a selected one of the said figure-8 coils on the primary side is switched to connect to power supply so as to maximize an output of the coil on the secondary side.

The present invention specifically further provides, as set forth in claim 7, a contactless power transmission system as set forth in claim 6, characterized in that a said plurality of figure-8 coils on the primary side are displaced and oriented so that adjacent ones of them make an angle set identically to one another. For example, if three figure-8 coils are used, they are defined here to make an angle of 120°.

The present invention specifically further provides, as set forth in claim 8, a contactless power transmission system as set forth in claim 6, characterized in that a said plurality of figure-8 coils on the primary side are displaced and oriented so that adjacent ones of them make an angle randomly set. Where an angle is randomly made by the adjacent coils, a plurality of figure-8 coils on the primary side can be disposed in an increased concentration, making it possible for the figure-8 coil on the secondary side to provide a further increased output.

The present invention specifically provides, as set forth in claim 9, a contactless power transmission system as set forth in any one of claims 1 to 8, characterized in that plates of a soft magnetic material are disposed each on a side of a said power coil on one of the primary and secondary sides which is opposite to the side which faces a said power coil on the other of the primary and secondary sides as its counterpart.

The present invention specifically provides, as set forth in claim 10, a contactless power transmission system as set forth in claim 9, characterized in that the said soft magnetic material is M n-Zn ferrite or Ni—Cu—Zn ferrite. Ni—Cu—Zn ferrite is superior to Mn—Zn ferrite in performance against dielectric breakdown.

In accordance with the present invention there is also provided, as set forth in claim 11, a contactless power transmission method using a near electromagnetic field, characterized in that it comprises:

preparing a power feeding coil made up of a plurality of power coils disposed adjoining one another on a primary side and a power receiving coil made up of a plurality of power coils disposed adjoining one another on a secondary side; and

configuring a said plurality of adjoining power coils on each of the primary and secondary sides by positioning and laying them one on another to coincide in part so that a noise from a leakage electromagnetic field being generated during power transmission, an external noise and a noise that the said power feeding and receiving coils themselves are emitting outwards are thereby canceled out.

In accordance with the present invention there is also provided, as set forth in claim 12, a contactless power transmission method using a near electromagnetic field for transmitting electric power from a power feeding coil to a power receiving coil without their mutual contact and using electromagnetic induction, characterize in that it comprises:

making up the said power feeding coil of a plurality of power coils disposed adjoining one another on a primary side, a said plurality of adjoining power coils on the primary side generating magnetic fluxes varied in orientation from one another, and making up the said power receiving coil of a plurality of power coils disposed adjoining one another on a secondary side, a said plurality of adjoining power coils on the secondary side generating magnetic fluxes varied in orientation from one another; and

configuring a said plurality of power coils on each of the primary and secondary sides by positioning and laying them one on another to coincide in part so that a noise from a leakage electromagnetic field being generated during power transmission, an external noise and a noise that the said power feeding and receiving coils themselves are emitting outwards are thereby canceled out.

The present invention specifically provides, as set forth in claim 13, a contactless power transmission method using a near electromagnetic field as set forth in claim 11 or claim 12, characterized in that the said adjoining power coils of each on the said primary and secondary sides comprise a pair of planar spiral coils which are shaped in the form of a figure 8 and connected differentially to power supply, and each of the said spiral coils being D-shaped having a semicircular portion and a linear portion combined together, the two spiral coils having their linear portions laid one on the other to form a planar figure-8 coil.

The present invention specifically further provides, as set forth in claim 14, a contactless power transmission method using a near electromagnetic field as set forth in any one of claims 11 to 13, characterized in that a said plurality of adjoining power coils on the said primary side have a single power supply for connection thereto.

The present invention specifically also provides, as set forth in claim 15, a contactless power transmission method using a near electromagnetic field as set forth in as set forth in any one of claims 11 to 13, characterized in that a said plurality of adjoining power coils on the said primary side have a plurality of power supplies for connection thereto.

The present invention specifically provides, as set forth in claim 16, a contactless power transmission method using a near electromagnetic field as set forth in claim 13, characterized in that on the primary side a said plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a said figure-8 coil on the secondary side, leading to a lowering of power transmission efficiency, a selected one of the said figure-8 coils on the primary side is switched to connect to power supply so as to maximize an output of the coil on the secondary side.

The present invention specifically further provides, as set forth in claim 17, a contactless power transmission method using a near electromagnetic field as set forth in as set forth in claim 16, characterized in that a said plurality of figure-8 coils on the primary side are displaced and oriented so that adjacent ones of them make an angle set identically to one another.

The present invention specifically also provides, as set forth in claim 18, a contactless power transmission method using a near electromagnetic field as set forth in as set forth in claim 16, characterized in that a said plurality of figure-8 coils on the primary side are displaced and oriented so that adjacent ones of them make an angle randomly set. Disposing power coils on the primary side so that they make a random angle allows the power coils on the primary side to be disposed in an increased concentration, providing an increased output from power coils on the secondary side.

The present invention specifically provides, as set forth in claim 19, a contactless power transmission method using a near electromagnetic field as set forth in any one of claims 11 to 18, characterized in that a plate of a soft magnetic material is disposed on a side of a said power coil on one of the primary and secondary sides which is opposite to the side which faces a said power coil on the other of the primary and secondary side as its counterpart.

The present invention specifically further provides, as set forth in claim 20, a contactless power transmission method using a near electromagnetic field as set forth in claim 19, characterized in that the said soft magnetic material is Mn—Zn ferrite or Ni—Cu—Zn ferrite.

### Effects of the Invention

According to the contactless power transmission system of claims 1, 2, 3 and 4, a contactless power transmission apparatus can be provided in which power coils on the primary and secondary sides can be used to transmit power efficiently, and noises from leakage magnetic field during power transmission, external noises and noises being emitted outside from the primary and secondary power coils themselves can effectively be canceled out.

According to the contactless power transmission system of claim 5, a contactless power transmission apparatus can be provided in which providing a plurality of power supplies for power coils on the primary side allows electric currents for passage through adjoining power coils on the primary side to be individually adjusted, improving the efficiency of power transmission.

According to the contactless power transmission system of claims 6, 7 and 8, a contactless power transmission apparatus can be provided in which switching between adjoining power coils on the primary side can optimize positions of power coils on the primary side and those on the secondary side relative to each other and can maximize the efficiency of power transmission.

According to the contactless power transmission system of claims 9 and 10, a contactless power transmission apparatus can be provided in which using a soft magnetic material allows diminishing leakage magnetic fluxes.

According to the contactless power transmission method of claims 11, 12, 13 and 14, a contactless power transmission technique can be provided in which power coils on the primary and secondary side can be used to transmit power efficiently, and noises from leakage magnetic field during power transmission, external noises and noises being emitted outside from the primary and secondary power coils themselves can effectively be canceled out.

According to the contactless power transmission method of claim 15, a contactless power transmission technique can be provided in which providing a plurality of power supplies for power coils on the primary side allows electric currents for passage through adjoining power coils on the primary side to be individually adjusted, improving the efficiency of power transmission.

According to the contactless power transmission method of claims 16, 17 and 1, a contactless power transmission technique can be provided in which switching between adjoining power coils on the primary side can optimize positions of power coils on the primary side and those on the secondary side relative to each other and can maximize the efficiency of power transmission.

According to the contactless power transmission method of claims 19 and 20, a contactless power transmission technique can be provided in which using a soft magnetic material allows diminishing leakage magnetic fluxes.

According to the present invention, a contactless power transmission apparatus and technique can be provided in which noises being emitted outside of the power coils on the primary and secondary sides themselves for power transmission can be canceled out, leakage magnetic fluxes from the primary and secondary power coils can be diminished and a deviation in position of the power coils on the primary side can be responded to, thereby maximizing the efficiency of power transmission.

### BRIEF DESCRIPTION OF THE DRAWINGS

FIG. 1 illustrates how a figure-8 power coil is configured, in which FIG. 1(a) is a plan view of a spiral coil and FIG. 1(b) is a plan view of the figure-8 power coil;

FIG. 2 illustrates a contactless power transmission system in which two figure-8 power coils are laid one above the other across a gap spacing;

FIG. 3 illustrates a contactless power transmission system in which two figure-8 power coils are likewise laid one above the other and further a plate of soft magnetic material is disposed on the back side of each of them;

FIG. 4 illustrates modeled power coils made experimentally in Example 1, conforming a distribution of magnetic fields during power transmission by a field analyzing software;

FIG. 5 illustrates modeled power coils made experimentally in Example 2, conforming a distribution of magnetic fields during power transmission by a field analyzing software;

FIG. 6 illustrates power feeding power coils (three primary coils laid one on another to coincide in part) and power receiving coils (one secondary coil), in which FIG. 6(a) is a view illustrating a structure of the power feeding coils (primary coils) where three figure-8 power coils are disposed displaced by an angle of 120° and laid one on another to coincide in part, FIG. 6(b) is a view illustrating a structure of the power receiving coils constituting one figure-8 power coil which is identical in size and shape to a said power feeding coil shown in FIG. 6(a), FIG. 6(c) is a view illustrating power feeding coils constituted by individual figure-8 power coils before they are laid one on another and their relation for connection to a power supply circuit, and FIG. 6 (d) is a view illustrating power feeding coils constituted by individual figure-8 power coils after they are laid one on another and their relation in position to power receiving coils;

FIG. 7 is a view showing an appearance of a figure-8 power coil actually made;

FIGS. 8(a), 8(b) and 8(c) are views confirming distributions of magnetic fields during power transmission by a field analysis software, where a plate of soft magnetic material is disposed, only on power coils on the primary side, only on power coils on the secondary side and on power coils on each of both the primary and secondary sides, respectively;

FIG. 9 are views confirming distributions of magnetic fields during power transmission by a field analysis software, where the distance of gap spacing between power coils on the primary side and power coils on the secondary side is set at 20 mm, 40 mm and 80 mm, respectively, under the condition that a plate of soft magnetic material is disposed on power coils on each of the primary side and the secondary side; and

FIG. 10 is a graph that exhibits a relationship between the efficiency of electric power transmission and the distance between the power coils on the primary side and the power coils on the secondary side.

### BRIEF DESCRIPTION OF REFERENCE CHARACTERS

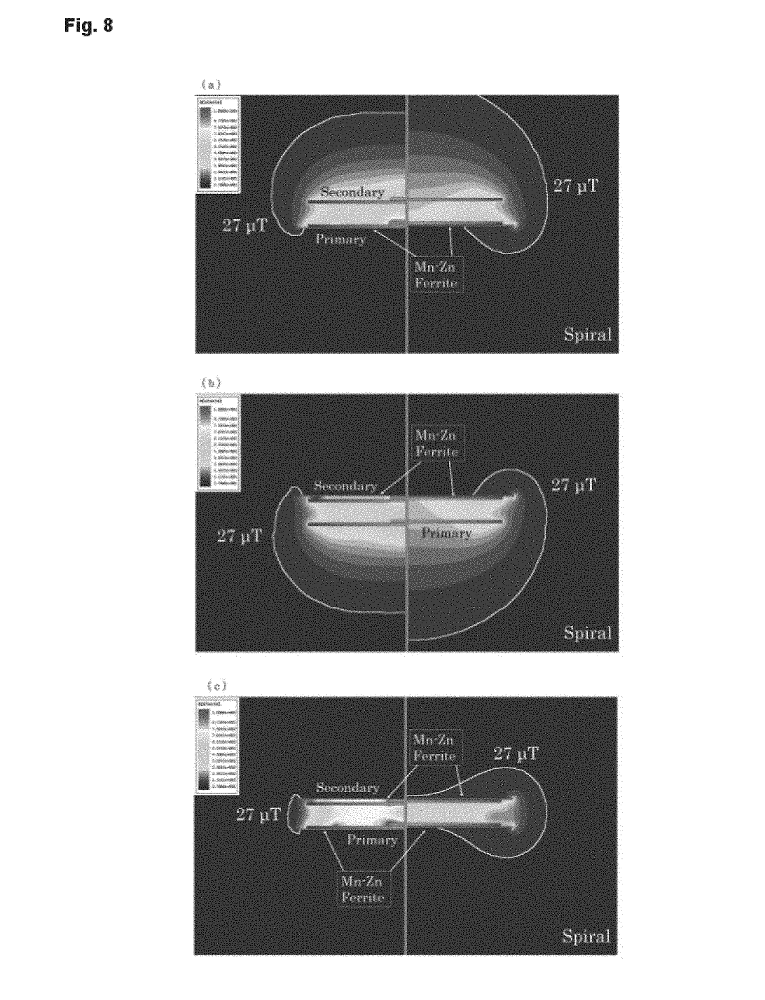

1 power coils shaped in the form of a figure 8
2 a figure-8 primary coil
3 a figure-8 secondary coil
4, 41 a plate of soft magnetic material
11, 12 a spiral coil
11a a semicircular portion of the spiral coil
11b, 11c, 11d
   a linear portion of the spiral coil
5 a first figure-8 primary coil
6 a second figure-8 primary coil
7 a third figure-8 primary coil
8 a figure-8 secondary coil
20 a superposed primary coil
101, 102, 103
   a changeover switch

### Forms of Carrying Out the Invention

A contactless power transmitting system implemented in accordance with the present invention is characterized in that it comprises a power feeding coil made up of a plurality of power coils disposed adjoining one another on a primary side and a power receiving coil made up of a plurality of power coils disposed adjoining one another on a secondary side, wherein the power coils adjoining on each of the primary and secondary sides are positioned and laid one on another in contact in part so that a noise from a leakage electromagnetic field being generated during power transmission, an external noise and a noise that the power feeding and receiving coils themselves are emitting outwards are canceled out.

A contactless power transmitting system also implemented in accordance with the present invention for transmitting electric power from a power feeding coil to a power receiving coil without their mutual physical contact by electromagnetic induction, is characterized in that the power feeding coil is made up of a plurality of power coils disposed adjoining one another on a primary side, a said plurality of adjoining power coils on the primary side generating magnetic fluxes opposed in orientation to one another, the secondary winding is made up of a plurality of power coils disposed adjoining one another on the secondary side, a said plurality of adjoining power coils on the secondary side generating magnetic fluxes opposed in orientation to one another, and the adjoining power coils on each of the primary and secondary sides are positioned and laid one on another in contact in part so that a noise from a leakage electromagnetic field being generated during power transmission, an external noise and a noise that the power feeding and receiving coils themselves are emitting are thereby canceled out.

It should be noted here that the noise from the electromagnetic field as generated during the power transmission refers to a noise that may be caused by a magnetic field generated in the power feeding and receiving coils as it interferes with or reflects on an environmental component (of metal or magnetic material). The external noise refers to a noise caused meteorically by a lightening surge, from electric power lines and generated by a neighboring electronic instrument. And, the noise being emitted outwards from the power feeding and receiving coils themselves refers to a noise that is caused mainly by a power supply system in the primary, power feeding coil fed with electric current and also likewise in the secondary coil which receives electric power from the primary coil.

And, the power coils on the primary side may preferably comprise a planar pair of spiral coils which are shaped in the form of a figure 8 and differentially connected to power input, and the power coils on the secondary side comprises a planar pair of spiral coils which are shaped in the form of a figure 8 and differentially connected to power output. Each of these and those spiral coils is D-shaped to have a semicircular portion and a linear portion made continuous to each other. Two planar spiral coils are placed to lay their linear portions one on the other, forming a planar figure-8 coil.

A plurality of the adjoining power coils on the primary side have a single power supply or a plurality of power supplies for connection thereto. With a plurality of power supplies connected to a plurality of the adjoining power feeding coils, it is made possible for electric currents passed through the adjoining power coils individually to be adjusted on the primary side, permitting the contactless power transmission system to be of a further improved transmission efficiency.

A contactless power transmission system further implemented in accordance with the present invention is characterized in that on the primary side a plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a figure-8 coil on the secondary side, leading to a lowering of power transmission efficiency, a selected one of the figure-8 coils on the primary side is switched to connect to power supply so as to maximize an output of the coil on the secondary side.

A said plurality of figure-8 coils on the primary side are displaced and oriented so that adjacent ones of them make an angle set identically to one another, or a said plurality of figure-8 coils on the primary side are displaced and oriented so that adjacent ones of them make an angle randomly set. Where an angle is randomly made by the adjacent figure-8 coils, a plurality of such coils on the primary side can be disposed in an increased concentration, making it possible for the coil on the secondary side to provide a further increased output.

A plate of a soft magnetic material is preferably disposed on a side of a said power coil on one of the primary and secondary sides which is opposite to the side which faces a said power coil on the other of the primary and secondary sides as its counterpart. The soft magnetic material is preferably, but not limited to, Mn—Zn ferrite or Ni—Cu—Zn ferrite

A contactless power transmitting method is further implemented in accordance with the present invention, the method being characterized in that it comprises preparing a power feeding coil made up of a plurality of power coils disposed adjoining one another on a primary side and a power receiving coil made up of a plurality of power coils disposed adjoining one another on a secondary side; and configuring a said plurality of adjoining power coils on each of the primary and secondary sides by positioning and laying them one on another in contact in part so that a noise from a leakage electromagnetic field being generated during power transmission, an external noise and a noise that said power feeding and receiving coils themselves are emitting outwards are thereby canceled out.

A contactless power transmitting method using a near electromagnetic field for transmitting electric power from a power feeding coil to a power receiving coil without their mutual contact and using electromagnetic induction is also implemented in accordance with the present invention, the method being characterized in that it comprises making up the said power feeding coil of a plurality of power coils disposed adjoining one another on a primary side, a said plurality of adjoining power coils on the primary side generating magnetic fluxes opposed in orientation to one another, and making up the said power receiving coil of a plurality of power coils disposed adjoining one another on a secondary side, a said plurality of adjoining power coils on the secondary side generating magnetic fluxes opposed in orientation to one another, and configuring a said plurality of power coils on each of the primary and secondary sides by positioning and laying them one on another in contact in part so that a noise from a leakage electromagnetic field being generated during power transmission, an external noise and a noise that the said power feeding and receiving coils themselves are emitting outwards are thereby canceled out.

It should be noted here that the power coils on the primary side may preferably comprise a planar pair of spiral coils which are shaped in the form of a figure 8 and differentially connected to power input, and the power coils on the secondary side comprises a planar pair of spiral coils which are shaped in the form of a figure 8 and differentially connected to power output. Each of these and those spiral coils is D-shaped to have a semicircular portion and a linear portion made continuous to each other. Two planar spiral coils are placed to lay their linear portions one on the other, forming a planar figure-8 coil.

A contactless power transmission method is further implemented in accordance with the present invention, the method being characterized in that on the primary side a plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a said figure-8 coil on the secondary side, leading to a lowering of power transmission efficiency, a selected one of the figure-8 coils on the primary side is switched to connect to power supply so as to maximize an output of the coil on the secondary side.

The method may further be characterized in that a said plurality of figure-8 coils on the primary side are displaced and oriented so that adjacent ones of them make an angle set identically to one another, or a said plurality of figure-8 coils on the primary side are displaced and oriented so that adjacent ones of them make an angle randomly set.

Mention is here made of the term “near electromagnetic field”. The region where a wave impedance varies largely from a free-space impedance in the neighborhood of a radiation source is referred to as the near electromagnetic field. A field in which an electromagnetic field whose wavelength λ is up to and far from λ/2π is termed as a near and a far electromagnetic field, respectively. For example, if frequency is 100 kHz, then λ≈3 km and λ/2π≈0.5 km, and a range of 0.5 km or less represents that of a near electromagnetic field at a frequency of 100 kHz.

### Example 1

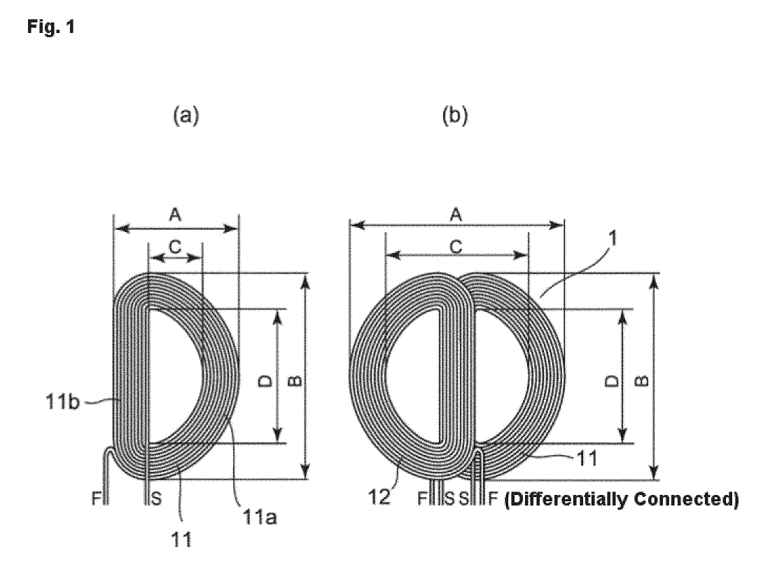

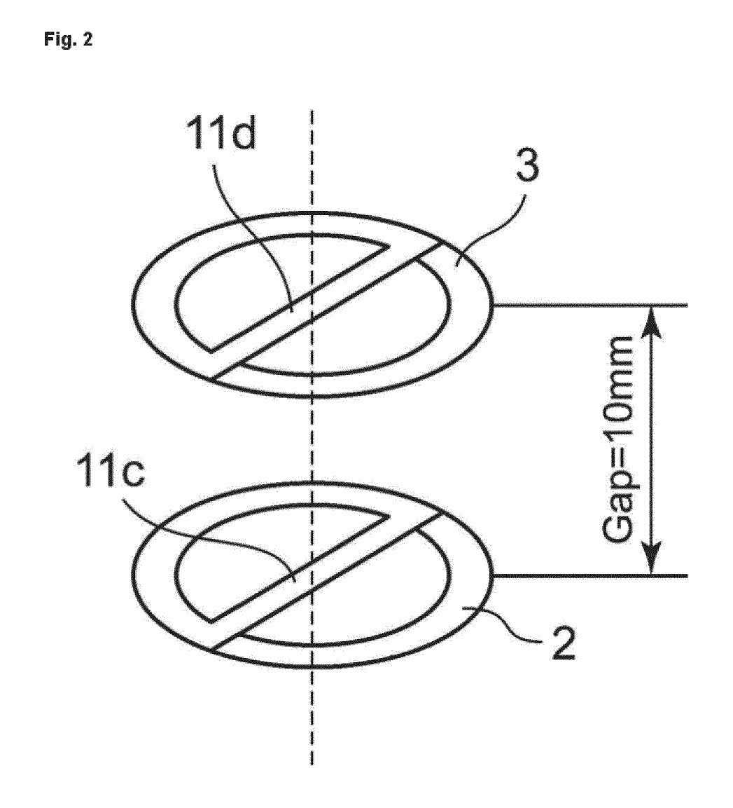

FIG. 1(b) is a plan view of a figure-8 coil 1 implemented in Example 1. The figure-8 coil has a pair of spiral coils 11 and 12 which are connected differentially to power supply. FIG. 1(a) is a view of the spiral coil 11. To make up the primary, power feeding coil and the secondary, power receiving coil, a pair of such figure-8 coils 2 and 3 are opposed to, and spaced across a gap spacing from, each other as shown in FIG. 2 to provide a contactless power transmission system.

Each (1) of the figure-8 coils 2 and 3 is configured as follows:

(1) Two spiral coils 11 and 12, each wound and shaped in the form of D, are superposed and differentially connected (to power input or output).

(2) Each D-shaped spiral coil 11, 12 is sized as shown in FIG. 1 to have:

an outer diameters of A=46.5 mm and B=47 mm,

an inner diameters of C=20.5 mm and D=52 mm, and

a number of turns of 10 t.

(3) The figure-8 coil 1 with the two D-shaped spiral coils 11 and 12 superposed is sized as shown in FIG. 2 to have:

an outer diameters of A=80 mm and B=75 mm,

an inner diameters of C=55 mm and D=52 mm, and

a number of turns of 10 t.

(4) The coils have characteristics (inductance L, resistance r):

D-shaped: L=6.6 μH and r=64 mΩ

Figure 8: L=15 μH and r=128 mΩ

Examination Results:

Ex. 1

(1) Two figure-8 coils are disposed in opposition to and spaced from each other.
They are oriented in lines.

(2) Power is transmitted across a gap spacing of 10 mm between the coils.

Measurement Conditions:
Under resonance conditions with capacitance of 43 μF connected in series
Load: resistance of 10Ω
Drive frequency f=200 kHz, sine wave input
Measured by a power meter

(3) Results:

TABLE 1

| | Vin | Iin | Pin | | Vout | Iout | Pout | | Effi- |
|---|---|---|---|---|---|---|---|---|---|
| | (V) | (A) | (W) | λ in | (V) | (A) | (W) | λ out | ciency |
| FIG.-8 | 2.92 | 1.1 | 2.97 | 0.926 | 5.05 | 0.5 | 2.52 | 0.992 | 84.76 |
| coil | | | | | | | | | |
| w/10 t | | | | | | | | | |

V: voltage,
I: current,
P: power,
λ: power factor,
in: primary (power feeding) side,
out: secondary (power receiving) side

Output at a transmission efficiency η=84% was confirmed
Comparison: Efficiency of a conventional spiral coil was 91%

(4) Experimental coils were modeled where magnetic field distributions during power transmission were ascertained with an electromagnetic field analysis software.

For comparison purposes, an assessment was made with reference to conventional spiral coils sized correspondingly.

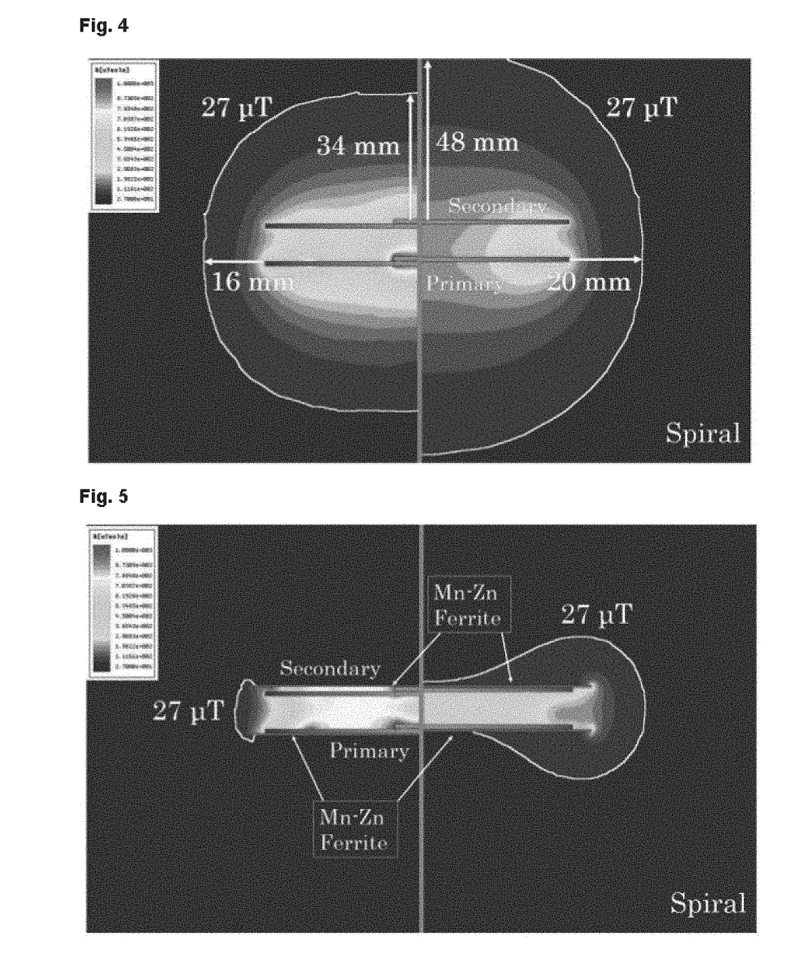

The view in FIG. 4 exhibits the magnetic field distributions for the modeled experimental coils during power transmission, which are identified by the electromagnetic field analysis software.

In the view of FIG. 4, white lines each indicate a boundary of the area of a magnetic flux density of 27 μT, a value in the ICNIRP guideline.

With the gap spacing of 10 mm between the primary and secondary coils, the distance over which the magnetic field flux density becomes 27 μT or less of the ICNIRP guideline is:

Coil upwards (on the central axis), 34 mm for the figure-8 coil which is, less than, and, 71% of 48 mm, for the spiral coil, and

Coil sideways (on the desktop surface), 16 mm for the figure-8 coil which is, less than, and, 80% of 20 mm, for the spiral coil.

### Example 2

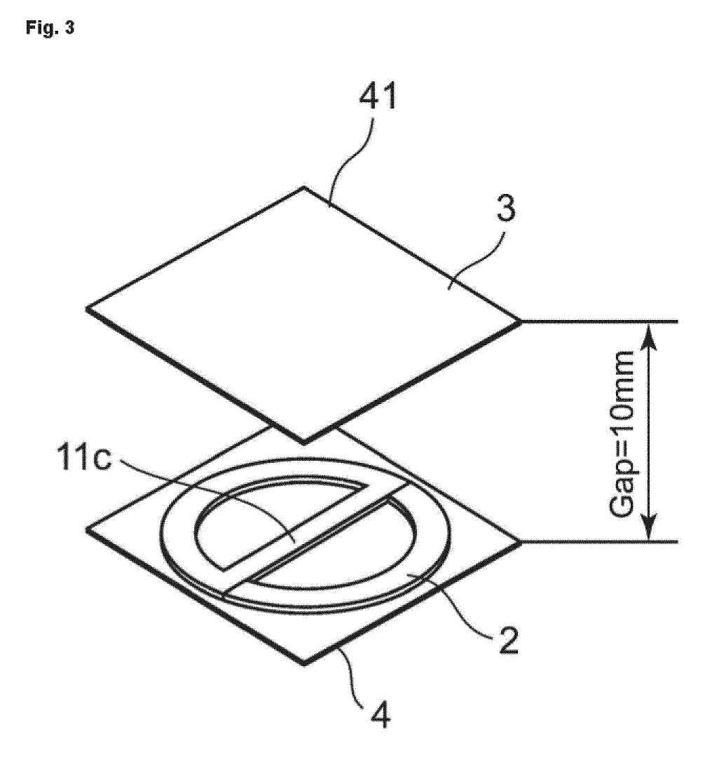

FIG. 3 is a view illustrating a contactless power transmission system in which a secondary figure-8 coil 3 is laid above a primary figure-8 coil 2 and plates of soft magnetic material 4 and 41 are disposed on the rear, opposite sides of the figure-8 coils 2 and 3, respectively.

Ex. 2

(1) A plate of soft magnetic material composed of Mn—Zn ferrite and having a size of 90 mm×90 mm×0.5 mm is disposed on the rear side of each of the figure-8 coils.

(2) The two figure-8 coils are disposed opposed to each other and oriented in lines.

(3) The gap spacing between the primary and secondary coils is set at 10 mm, and power is then transmitted.

Measurement Conditions:
Under resonance conditions with capacitance of 43 μF connected in series
Load: resistance of 10Ω
Drive frequency f=200 kHz, sine wave input
Measured by a power meter

(4) Results:

TABLE 2

| | | | | | | | | | Effi- |
|---|---|---|---|---|---|---|---|---|---|
| | Vin | Tin | Pin | | Vout | Iout | Pout | | cien- |
| | (V) | (A) | (W) | λ in | (V) | (A) | (W) | λ out | cy |
| FIG.-8 | 7.32 | 0.37 | 2.64 | 0.98 | 5.05 | 0.5 | 2.51 | 0.99 | 95.21 |
| coil | | | | | | | | | |
| w/10 t | | | | | | | | | |

V: voltage,
I: current,
P: power,
λ: power factor,
in: primary (power feeding) side,
out: secondary (power receiving) side

Output at an efficiency η=95% was confirmed
Comparison: Efficiency of a conventional spiral coil was 97%

(4) Experimental coils were modeled where magnetic field distributions during power transmission were ascertained with an electromagnetic field analysis software.

For comparison purposes, an assessment was made with reference to conventional spiral coils each sized correspondingly.

The view in FIG. 5 exhibit the magnetic field distributions for the modeled experimental coils during power transmission, which are identified by the electromagnetic field analysis software.

In the view of FIG. 5, white lines each indicate a boundary of the area of a magnetic flux density of 27 μT, a value in the ICNIRP guideline.

With the gap spacing of 10 mm between the primary and secondary coils, the distance over which the magnetic field flux density becomes 27 μT or less of the ICNIRP guideline is:

Coil upwards (on the central axis), 0 mm for the figure-8 coil, which is, less than, and, 0.89 mm for the spiral coil, and

Coil sideways (on the desktop surface), 2.6 mm for the figure-8 coil which is much less than 13.8 mm for the spiral coil.

### Example 3

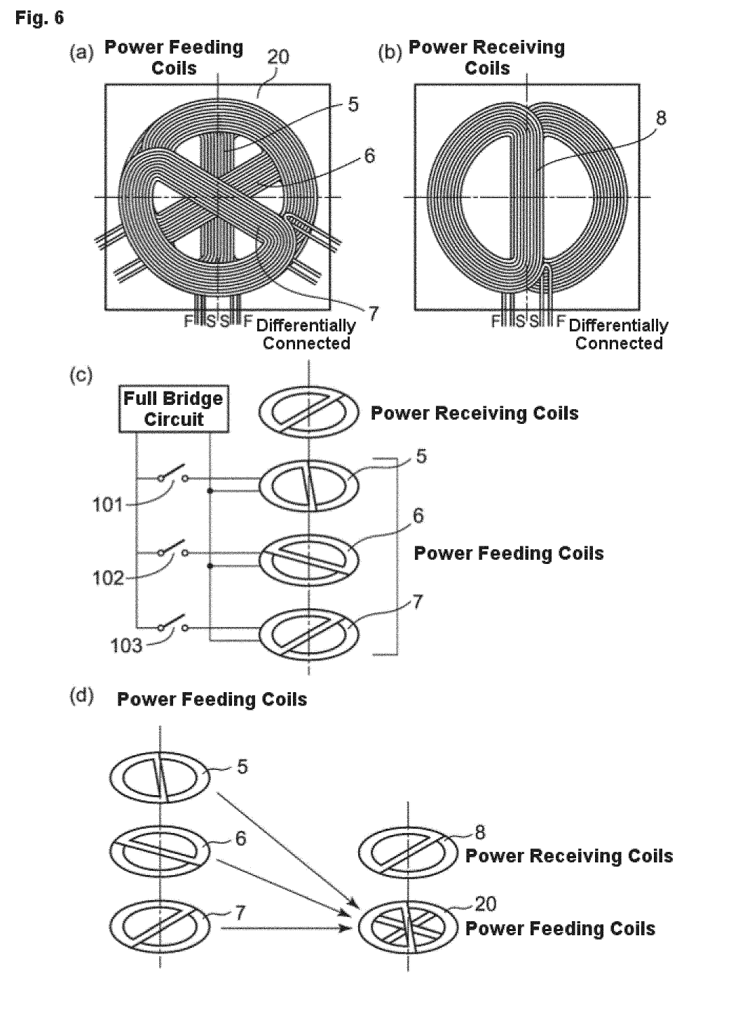

FIG. 6 illustrates a form of implementation in this example which comprises power feeding power coils (three primary figure-8 coils laid one on another in contact in part) and power receiving coils (one secondary figure-8 coil), in which FIG. 6(a) is a view illustrating a structure of the power feeding coils (primary coils) where three figure-8 power coils 5, 6 and 7 are disposed displaced by an angle of 120° and laid one on another in contact in part, FIG. 6(b) is a view illustrating a structure of the power receiving coils constituting one figure-8 power coil which is identical in size and shape to a said power feeding coil 5, 6, 7 shown in FIG. 6(a), FIG. 6(c) is a view illustrating power feeding coils constituted by individual figure-8 power coils before they are laid one on another and their relation for connection to a power supply circuit, and FIG. 6 (d) is a view illustrating power feeding coils constituted by individual figure-8 power coils after they are laid one on another and their relation in position to power receiving coils.

It should be noted here that if there occurs a deviation in position of the central axis between the figure-8 coils 5, 6 and 7 on the power feeding or primary side and a figure-8 coil on the power receiving or secondary side, leading to a lowering of power transmission efficiency, a bridge circuit is switched to connect an optimum one of the figure-8 coils 5, 6 and 7 on the primary side to power supply so as to maximize an output of the figure-8 coil on the secondary side.

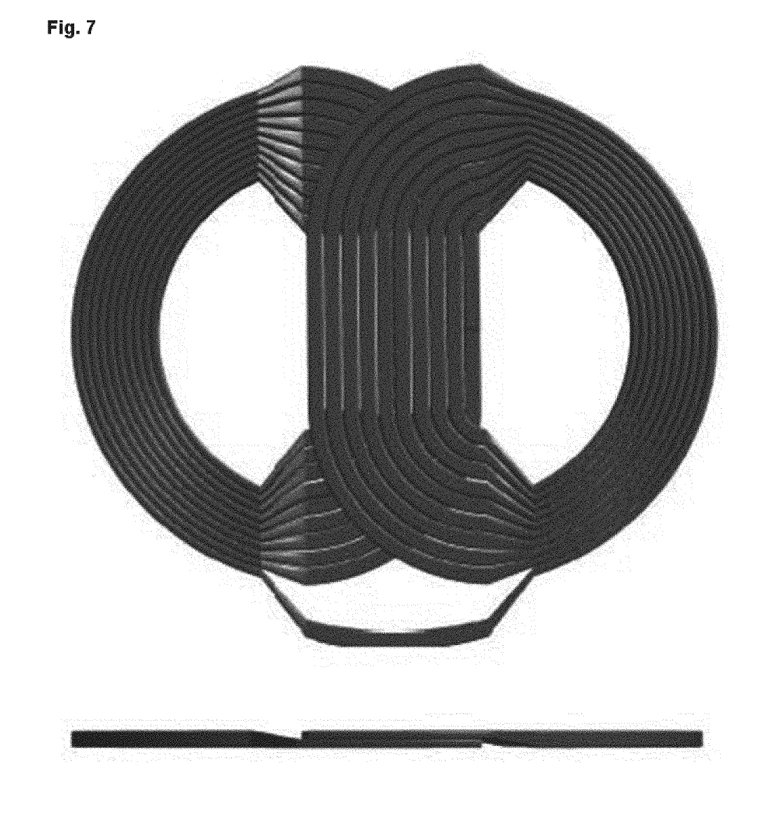

While in FIG. 6 the figure-8 coils 5, 6 and 7 on the power feeding side are shown and described to be displaced by an equal angle of 120°, this is not a limitation. The angle may not be set identically but may be set randomly. Further, the figure-8 coils on the power feeding side may not be limited to three in number but may be more than three in number. FIG. 7 is a view showing an appearance of a figure-8 power coil actually made.

### Example 4

In FIG. 8, FIGS. 8(a), 8(b) and 8(c) are views confirming distributions of magnetic fields during power transmission under the conditions of previous Example 2 above by an electromagnetic field analysis software, where a plate of soft magnetic material is disposed, only on power coils on the primary side, only on power coils on the secondary side and each on both the primary and secondary sides, respectively. The drive frequency is 200 kHz and the plate of soft magnetic material is composed of Mn—Zn ferrite. It is seen that FIG. 8(c) agrees in conditions with FIG. 5 in previous Example 2. With a plate of soft magnetic material disposed on each of the primary and secondary coils, it is evident that the leakage magnetic flux density is much more diminished.

### Example 5

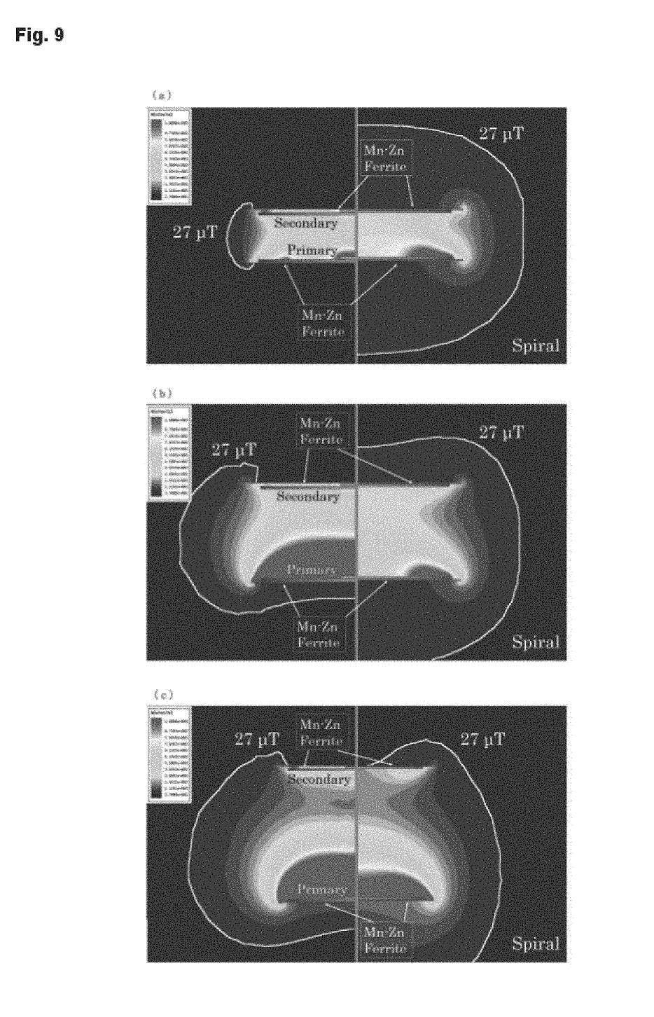

In FIG. 9, FIGS. 9(a), 9(b) and 9(c) are views confirming distributions of magnetic fields during power transmission by a field analysis software, where the distance changed between power coils on the primary side and power coils on the secondary side is set at 20 mm, 40 mm and 80 mm, respectively, under the condition that a plate of soft magnetic material is disposed each on both the coils on the primary side and the coils on the secondary side. The drive frequency is 200 kHz.

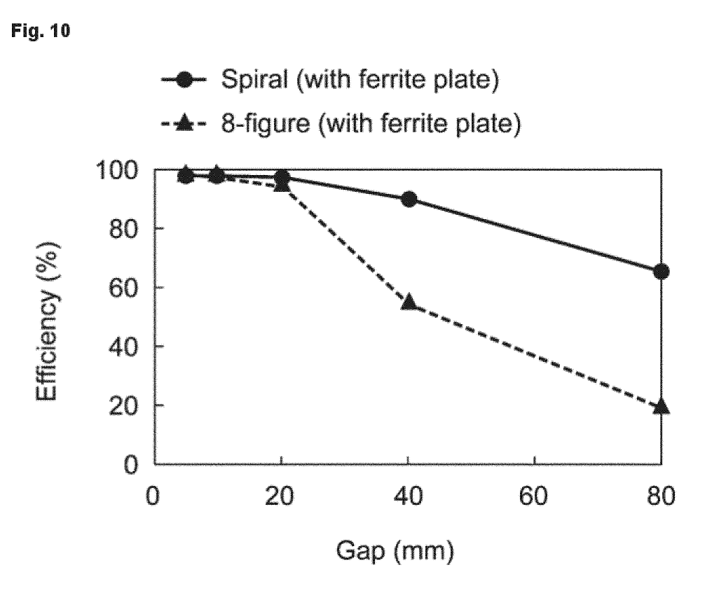

FIG. 10 is a graph that shows a relationship between the efficiency of electric power transmission and the distance between the power coils on the primary side and the power coils on the secondary side. From FIG. 10, it is seen that the practical distance between the power coils on the primary side and the power coils on the secondary side is 20 mm or less.

### INDUSTRIAL APPLICABILITY

According to the present invention, there is provided a contactless power transmission system and method whereby noises being emitted outside from primary and secondary power coils themselves can be canceled out and, furthermore, leakage magnetic fluxes from the primary and secondary coils can be diminished. And, with the primary coils disposed angularly displaced and superposed one on another, it is possible to respond to an axial deviation in position between the primary and secondary power coils from an optimum positional relationship by selectively switching on any one of the primary coils, thereby maximizing the efficiency of power transmission. The invention can widely be applied to mobile devices, electric automobiles, implantable medical devices and other applications of noncontact or wireless power transmission or feeding technology, thereby contributing to development of industries.

1. A contactless power transmission system, comprising:
a power feeding coil made up of a plurality of power coils disposed adjoining one another on a primary side and
a power receiving coil made up of a plurality of power coils disposed adjoining one another on a secondary side, wherein
a said plurality of adjoining power coils on each of the primary and secondary sides are positioned and laid one on another to coincide in part so that a noise from a leakage electromagnetic field being generated during power transmission, an external noise and a noise that said power feeding and receiving coils themselves are emitting outwards are thereby canceled out.

2. A contactless power transmission system for transmitting electric power from a power feeding coil to a power receiving coil without their mutual contact and using electromagnetic induction, wherein:
said power feeding coil is made up of a plurality of power coils disposed adjoining one another on a primary side, a said plurality of adjoining power coils on the primary side generating magnetic fluxes varied in orientation from one another,
said power receiving coil is made up of a plurality of power coils disposed adjoining one another on a secondary side, a said plurality of adjoining power coils on the secondary side generating magnetic fluxes varied in orientation from one another, and
said adjoining power coils on each of said primary and secondary sides are positioned and laid one on another to coincide in part so that a noise from a leakage electromagnetic field being generated during power transmission, an external noise and a noise that said power feeding and receiving coils themselves are emitting outwards are thereby canceled out.

3. A contactless power transmission system as set forth in claim 1, wherein said adjoining power coils on each of said primary and secondary sides comprise a pair of planar spiral coils which are shaped in the form of a figure 8 and connected differentially to power supply, and each of said spiral coils is D-shaped having a semicircular portion and a linear portion combined together, the two spiral coils having their linear portions laid one on the other to form a planar figure-8 coil.

4. A contactless power transmission system as set forth in claim 1, wherein a said plurality of the adjoining power coils on said primary side have a single power supply for connection thereto.

5. A contactless power transmission system as set forth in claim 1, wherein a said plurality of the adjoining power coils on said primary side have a plurality of power supplies for connection thereto.

6. A contactless power transmission system as set forth in claim 3, wherein on the primary side a plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a figure-8 coil on the secondary side, leading to a lowering of power transmission efficiency, a selected one of said figure-8 coils on the primary side is switched to connect to power supply so as to maximize an output of the coil on the secondary side.

7. A contactless power transmission system as set forth in claim 6, wherein a said plurality of figure-8 coils on the primary side are displaced and oriented so that adjacent ones of them make an angle set identically to one another.

8. A contactless power transmission system as set forth in claim 6, wherein a said plurality of figure-8 coils on the primary side are displaced and oriented so that adjacent ones of them make an angle randomly set.

9. A contactless power transmission system as set forth in claim 1, wherein a plate of a soft magnetic material is disposed on a side of a said power coil on one of the primary and secondary sides which is opposite to that which faces a said power coil on the other of the primary and secondary sides.

10. A contactless power transmission system as set forth in claim 9, wherein said soft magnetic material is Mn—Zn ferrite or Ni—Cu—Zn ferrite.

11. A contactless power transmission method using a near electromagnetic field, comprising:
preparing a power feeding coil made up of a plurality of power coils disposed adjoining one another on a primary side and a power receiving coil made up of a plurality of power coils disposed adjoining one another on a secondary side; and
configuring a said plurality of adjoining power coils on each of the primary and secondary sides by positioning and laying them one on another to coincide in part so that a noise from a leakage electromagnetic field being generated during power transmission, an external noise and a noise that said power feeding and receiving coils themselves are emitting outwards are thereby canceled out.

12. A contactless power transmission method using a near electromagnetic field for transmitting electric power from a power feeding coil to a power receiving coil without their mutual contact and using electromagnetic induction, comprising:
making up said power feeding coil of a plurality of power coils disposed adjoining one another on a primary side, a said plurality of adjoining power coils on the primary side generating magnetic fluxes varied in orientation from one another, and making up said power receiving coil of a plurality of power coils disposed adjoining one another on a secondary side, a said plurality of adjoining power coils on the secondary side generating magnetic fluxes varied in orientation from one another; and
configuring a said plurality of power coils on each of the primary and secondary sides by positioning and laying them one on another to coincide in part so that a noise from a leakage electromagnetic field being generated during power transmission, an external noise and a noise that said power feeding and receiving coils themselves are emitting outwards are thereby canceled out.

13. A contactless power transmission method using a near electromagnetic field as set forth in claim 11, wherein said adjoining power coils of each on said primary and secondary sides comprise a pair of planar spiral coils which are shaped in the form of a figure 8 and connected differentially to power supply, and each of said spiral coils being D-shaped having a semicircular portion and a linear portion combined together, the two spiral coils having their linear portions laid one on the other to form a planar figure-8 coil.

14. A contactless power transmission method using a near electromagnetic field as set forth in claim 11, wherein a said plurality of adjoining power coils on said primary side have a single power supply for connection thereto.

15. A contactless power transmission method using a near electromagnetic field as set forth in as set forth in claim 11, wherein a said plurality of adjoining power coils on said primary side have a plurality of power supplies for connection thereto.

16. A contactless power transmission method using a near electromagnetic field as set forth in claim 13, wherein on the primary side a plurality of such figure-8 coils each having the linear and semicircular portions combined together are disposed angularly displaced with respect to their linear portions rotationally on a central axis thereof and if there occurs a deviation in position of the central axis between the figure-8 coils on the primary side and a said figure-8 coil on the secondary side, leading to a lowering of power transmission efficiency, a selected one of said figure-8 coils on the primary side is switched to connect to power supply so as to maximize an output of the coil on the secondary side.

17. A contactless power transmission method using a near electromagnetic field as set forth in as set forth in claim 16, wherein a said plurality of figure-8 coils on the primary side are displaced and oriented so that adjacent ones of them make an angle set identically to one another.

18. A contactless power transmission method using a near electromagnetic field as set forth in as set forth in claim 16, wherein a said plurality of figure-8 coils on the primary side are displaced and oriented so that adjacent ones of them make an angle randomly set.

19. A contactless power transmission method using a near electromagnetic field as set forth in claim 11, wherein a plate of a soft magnetic material is disposed on a side of a said power coil on one of the primary and secondary sides which is opposite to that which faces a said power coil on the other of the primary and secondary sides.

20. A contactless power transmission method using a near electromagnetic field as set forth in claim 19, wherein said soft magnetic material is Mn—Zn ferrite or Ni—Cu—Zn ferrite.
